(19) United States
(12) Patent Application Publication
(10) Pub. No.: US 2025/0093178 A1
(43) Pub. Date: Mar. 20, 2025

(54) DATA COLLECTING DEVICE AND DATA COLLECTING SYSTEM

(71) Applicant: TOYOTA JIDOSHA KABUSHIKI KAISHA, Toyota-shi (JP)

(72) Inventor: Masahiro TANAKA, Tokyo-to (JP)

(73) Assignee: TOYOTA JIDOSHA KABUSHIKI KAISHA, Toyota-shi (JP)

(21) Appl. No.: 18/660,457

(22) Filed: May 10, 2024

(30) Foreign Application Priority Data
Sep. 15, 2023 (JP) 2023-150386

(51) Int. Cl. G01C 21/00

(52) U.S. Cl. CPC G01C 21/3841; G01C 21/3822; G01C 21/3885

(57) ABSTRACT

A data collecting device has a processor configured to generate probe data representing a road feature based on information representing an environment around a vehicle, generate lane information representing a position of a lane in a road in which the vehicle was traveling when the road feature represented by the probe data was detected, based on information representing a lane marking line around the vehicle, transmit the lane information via a communication unit and receive a determination result representing whether or not there is a transmission request for transmitting the probe data, which is determined based on the lane information, and transmit the probe data via the communication unit when the determination result representing the transmission request is received.

### FIELD

The present invention relates to a data collecting device and a data collecting system.

### BACKGROUND

It is necessary that a high-precision map which the automatic driving system of the vehicle refers to for automatic driving of the vehicle accurately represents the information on the road. In particular, the high-precision map represents road features around the road. Therefore, probe data representing the road features around the road is collected from the vehicle actually traveling in the predetermined area.

The vehicle generates probe data while traveling on the road and transmits probe data to the server, and generates or updates the high-precision map based on the data.

When the road has multiple lanes, the server collects probe data for each lane. To generate map information for each lane, it is necessary to collect a predetermined number of probe data for each lane.

In the case of the road on the left side passage, it tends to be difficult to collect probe data on the leftmost lane compared to other lanes due to parked vehicles and the like.

For example, Japanese Unexamined Patent Publication No. 2020-140602 proposes a traveling probe collecting device that can efficiently collect traveling probe information for each lane by displaying a traveling request position where additional collection of traveling probe information for each lane is necessary, and thereby encourage the user to drive a vehicle according to the display.

### SUMMARY

However, vehicles collecting probe data are not always equipped with a high-precision map. In a vehicle without such a map, it is not possible to determine on which lane of the road the vehicle is traveling, and thus it is not possible to determine that the vehicle is traveling in a lane where collection of probe data is necessary.

It is an object of the present disclosure to provide a data collecting device capable of determining a position of a lane in a road on which a vehicle is traveling and collecting probe data without using a high-precision map.
(1) According to one embodiment, a data collecting device is provided, having a processor configured to generate probe data representing a road feature based on information representing an environment around a vehicle, generate lane information representing a position of a lane in a road in which the vehicle was traveling when the road feature represented by the probe data was detected, based on information representing a lane marking line around the vehicle, transmit the lane information via a communication unit and receive a determination result representing whether or not there is a transmission request for transmitting the probe data, which is determined based on the lane information, and transmit the probe data via the communication unit when the determination result representing the transmission request is received.
(2) In the data collecting device of embodiment (1) above, it is preferable that the lane information includes information representing whether the lane in which the vehicle is traveling on the leftmost side of the road, the rightmost side of the road, or other than the leftmost and rightmost sides of the road.
(3) In the data collecting device of embodiment (2) above, it is preferable that the lane information includes left side information representing a road feature partitioning the left end of the traveling lane relative to a direction of travel of the vehicle and right side information representing a road feature partitioning the right end of the traveling lane relative to the direction of travel of the vehicle.
(4) In the data collecting device of embodiments (1) to (4) above, it is preferable that the processor is further configured to generate a group of probe data including a plurality of the probe data for each predetermined data collection period, determine whether or not the vehicle has moved between lanes in a road within the data collection period, based on the information representing the lane marking line around the vehicle, and generate a first group of the probe data including a plurality of the probe data representing the road feature detected in a lane before movement between lanes and a second group of the probe data including a plurality of the probe data representing the road feature detected in a lane after movement between lanes, and a first group of the lane information including a plurality of the lane information representing a position of the lane before movement between lanes corresponding to the first group of the probe data and a second group of the lane information including a plurality of the lane information representing a position of a lane after movement between lanes corresponding to the second group of the probe data, when it has been determined that the vehicle has moved between lanes of the road within the data collection period.
(5) According to yet another embodiment, a data collecting system is provided. This data collecting system has a data collecting device has a device communication unit; and a device processor configured to generate probe data representing a road feature based on information representing an environment around a vehicle, generate lane information representing a position of a lane in a road in which the vehicle was traveling when the road feature represented by the probe data was detected, based on information representing a lane marking line around the vehicle, transmit the lane information via the device communication unit and receive a determination result representing whether or not there is a transmission request for transmitting the probe data, which is determined based on the lane information, and transmit the probe data via the device communication unit when the determination result representing the transmission request is received; and a server has a server communication unit; and a server processor configured to generate the determination result based on the lane information received via the server communication unit and collection lane information representing a lane for which it is necessary to collect the probe data, and transmit the determination result to the data collecting device via the server communication unit.

The data collecting device according to the present invention is capable of determining a position of a lane in a road in which a vehicle is traveling and collecting probe data without using a high-precision map.

The object and advantages of the invention will be realized and attained by means of the elements and combinations particularly specified in the claims. It is to be understood that both the foregoing general description and the following detailed description are exemplary and are not restrictive of the invention as claimed.

### BRIEF DESCRIPTION OF DRAWINGS

FIG. 1 is a schematic configuration diagram of a data collecting system in which the data collecting device of the present embodiment is implemented.

FIG. 2 is a sequence diagram of data collecting processing of the data collecting system of the present embodiment.

FIG. 3 is a schematic configuration diagram of a vehicle in which the data collecting device is mounted.

FIG. 4 is an example of an operation flowchart of data collecting processing of the data collecting device.

FIG. 5A is a diagram explaining the generation of the lane information and showing a vehicle traveling in the lane positioned at the leftmost side.

FIG. 5B is a diagram explaining the generation of the lane information and showing a vehicle traveling in the lane other than the leftmost and rightmost sides.

FIG. 5C is a diagram explaining the generation of the lane information and showing a vehicle traveling in the lane positioned at the rightmost side.

FIG. 6 is an example of an operation flowchart of lane change determination processing of the data collecting device.

### DESCRIPTION OF EMBODIMENTS

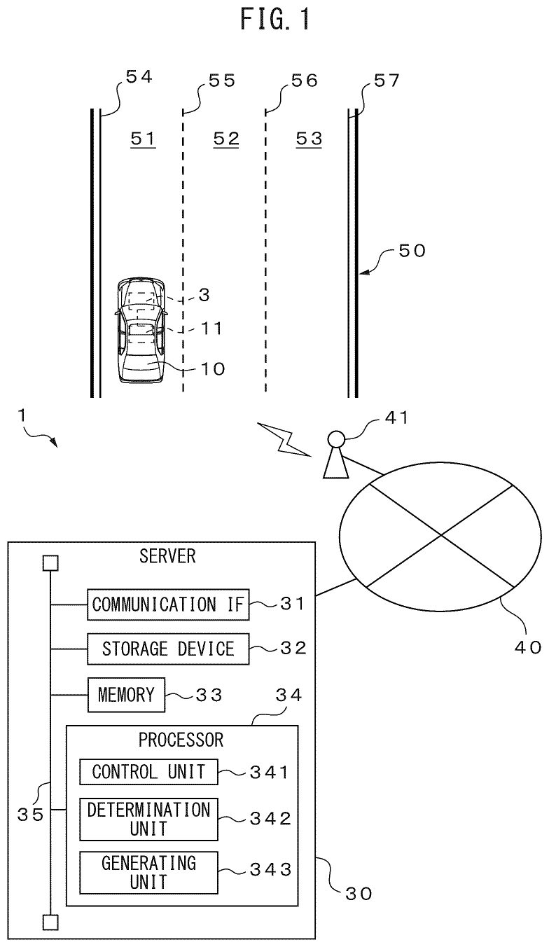

FIG. 1 is a schematic configuration diagram of the data collecting system 1 in which the data collecting device 11 of the present embodiment is implemented. The data collecting system 1 includes at least one vehicle 10 and a server 30. The data collecting device 11 is implemented in the vehicle 10. For example, the vehicle 10 is connected to the server 30 through the macrocell base station 41 and the communication network 40, by accessing the wireless base station 41 (hereinafter, also referred to as macrocell base station 41) that provides a macrocell connected to the communication network 40 to which the server 30 is connected via a gateway (not shown) or the like.

In FIG. 1, although only one vehicle 10 is shown, the data collecting system 1 may have a plurality of vehicles 10. Similarly, a plurality of macrocell base stations 41 may be connected to the communication network 40.

The vehicle 10 is traveling on a road 50. The road 50 has three lanes 51, 52, 53. The lane 51 is positioned at the leftmost side of the road 50. The lane 53 is positioned at the rightmost side of the road 50. The lane 52 is positioned other than the leftmost and rightmost sides of the road 50. The vehicle 10 is traveling in the lane 51.

The lane 51 is partitioned by a lane marking line 54 and a lane marking line 55. The lane 52 is partitioned by the lane marking line 55 and a lane marking line 56. The lane 53 is partitioned by the lane marking line 56 and a lane marking line 57. The lane marking line 54 and the lane marking line 57 are represented by the solid lines. The lane marking line 55 and the lane marking line 56 are represented by the chain lines.

The vehicle 10 generates probe data representing the road features and transmits probe data to the server 30. The server 30 receives probe data from the vehicle 10 and generates or updates high-precision maps. The high-precision map is referred to for the automatic driving vehicle to operate the vehicle automatically.

In a high-precision map, one road is represented as a series of multiple road sections. In addition, one lane is represented as a series of multiple lane sections. Each of the lane sections is associated with one road section.

When the road has multiple lanes, the server 30 collects probe data for each lane. In order to generate or update each lane of a high-precision map, it is necessary to collect a predetermined number of probe data for each lane. In the case of a road on the left side passage, collecting probe data from the leftmost lane is usually difficult compared to other lanes due to parked vehicles and other obstructions.

In the data collecting system 1, the vehicle 10 transmits probe data to the server 30 when the vehicle 10 is traveling in a lane where collection of probe data is necessary. On the other hand, when the vehicle 10 is traveling in a lane where collection of probe data is not necessary, the vehicle 10 does not transmit probe data to the server 30.

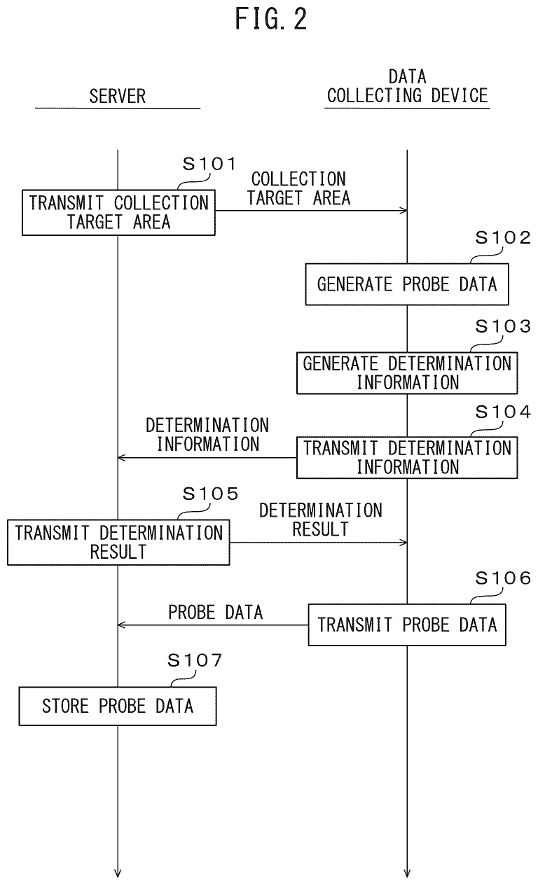

FIG. 2 is a sequence diagram of data collecting processing of the data collecting system 1. Referring to FIG. 2, an overview of the operation of the data collecting system 1 will be described below. In FIG. 1, although only one vehicle 10 is illustrated, the server 30 can perform the same processing for a plurality of vehicles.

First, the server 30 transmits the collection target area in which probe data is collected to the vehicle 10 through the communication network 40 and the macrocell base station 41 (step S101). The collection target area is designated, for example, for each of one or more consecutive road sections. The information representing the collection target area includes information capable of determining the road section with positioning information such as GNSS information. Further, in the server 30, the target number of probe data to be collected is set for each of the lane sections associated with the road section of the collection target area.

When the vehicle 10 enters the collection target area, the vehicle 10 starts to generate probe data representing the road features based on the information representing the environment around the vehicle 10 (step S102). The vehicle 10 generates a group of probe data including a plurality of probe data for each predetermined data collection period. For example, the vehicle 10 generates a group of probe data every predetermined period (e.g., 10 seconds to a few minutes) or each time the vehicle 10 travels a predetermined distance (e.g., 100 m to 1 km).

Next, the vehicle 10 generates determination information including lane information based on the information representing the lane marking lines around the vehicle 10 (step S103). The lane information represents the position of a lane in a road where the vehicle 10 was traveling when the road feature represented by probe data was detected. The determination information includes position information of the vehicle 10 when the road feature represented by prope data was detected, together with the lane information.

For example, the lane information includes information representing whether the lane in which the vehicle 10 is traveling is positioned at the leftmost side of the road, rightmost side of the road or other than the leftmost and rightmost sides of the road.

In the example shown in FIG. 1, the lane information represents that the lane 51 in which the vehicle 10 is traveling is positioned at the leftmost side of the road 50.

Next, the vehicle 10 transmits the determination information to the server 30 through the macro-cell base station 41 and the communication network 40 using the communication device 3 (step S104).

The server 30 generates a determination result based on the collection lane information and the determination information. The collection lane information represents lanes for which it is necessary to collect probe data. The server 30 transmit this determination result to the vehicle 10 through the communication network 40 and the macrocell base station 41 (step S105).

In the example shown in FIG. 1, the lane 51 in which the vehicle 10 travels is a lane for which it is necessary to collect probe data. The determination result includes a transmission request to send probe data.

Next, the vehicle 10 transmits probe data to the server 30 through the macrocell base station 41 and the communication network 40 using the communication device 3 (step S106).

The server 30 then stores probe data (step S107), and the series of processing steps is complete. The server 30 generates or updates a high-precision map using these probe data when a target number of probe data is collected for a lane section.

According to the data collecting system 1 of the present embodiment described above, it is capable of determining a position of a lane in a road in which the vehicle 10 is traveling and collecting probe data without using a high-precision map. As a result, the data collecting system 1 allows the vehicle 10 to transmit probe data to the server 30 when the vehicle 10 is traveling in a lane where collection of probe data is necessary. On the other hand, when the vehicle 10 is traveling in a lane where collection of probe data is not necessary, the vehicle 10 does not transmit probe data to the server 30.

Although a plurality of vehicles may be included in the data collecting system 1, the following will be described for one vehicle 10, since each vehicle may have the same configuration and perform the same processing with respect to the data collecting processing.

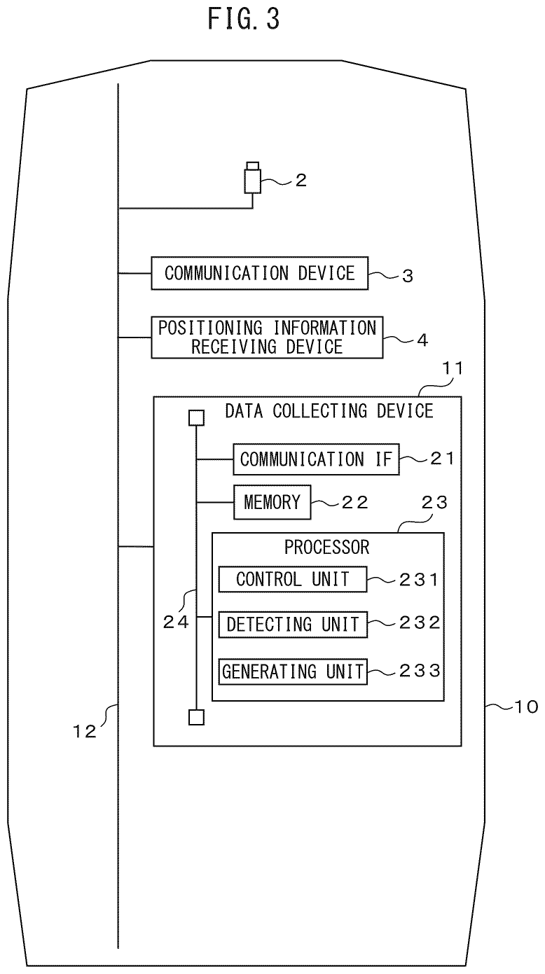

Next, the vehicle 10 on which the data collecting device 11 is mounted will be described below with reference to FIG. 3. FIG. 3 is a schematic configuration diagram of the vehicle 10 in which the data collecting device 11 is mounted.

The vehicle 10 includes a camera 2, a communication device 3, a positioning information receiving device 4, a data collecting device 11, and the like. The vehicle 10 may further include a ranging sensor (not shown) for measuring the distance of objects surrounding the vehicle 10, such as LiDAR sensor.

The camera 2, the communication device 3, the positioning information receiving device 4, and the data collecting device 11 are communicably connected via an in-vehicle network 12 conforming to a standard such as a controller area network.

The camera 2 is mounted to the vehicle 10 so as to face the front of the vehicle 10. The camera 2 acquires a camera image in which an environment of a predetermined area in front of the vehicle 10 is represented, for example, at a predetermined cycle. The camera image is an example of information representing the environment around the vehicle 10. The camera image may represent a road contained within a predetermined area and road features around the road in front of the vehicle 10.

The camera 2 has a 2D detector composed of an array of photoelectric conversion elements with visible light sensitivity, such as a CCD or C-MOS, and an imaging optical system that forms an image of the acquired region on the 2D detector.

The camera 2 outputs the camera image and the camera image acquisition time at which the camera image is acquired to the data collecting device 11 via the in-vehicle network 12 each time the camera image is acquired.

The communication device 3 has interface circuitry for connecting the data collecting device 11 to the macrocell base station 41. The communication device 3 is configured to communicate with the server 30 through the macrocell base station 41 and the communication network 40. The communication device 3 is an example of a device communication unit.

The positioning information receiving device 4 outputs the positioning information representing the current position of the vehicle 10. For example, the positioning information receiving device 4 may be a GNSS receiver. Every time the positioning information receiving device 4 acquires GNSS information at a predetermined reception period, the positioning information receiving device 4 outputs the positioning information and the positioning information acquitision time at which the GNSS information is acquired to the data collecting device 11 or the like. The positioning information includes, for example, the current position of the vehicle 10 represented by world coordinates. The current location of the vehicle 10 includes, for example, latitude and longitude.

The data collecting device 11 carries out control processing, detection processing, and generating processing. To this end, the data collecting device 11 includes a communication interface (IF) 21, a memory 22, and a processor 23. The communication interface 21, the memory 22, and the processor 23 are connected via signal wires 24. The communication interface 21 includes interface circuitry for connecting the data collecting system 11 to the in-vehicle network 12.

The memory 22 is an example of a storage unit, and for example, the memory 22 has a volatile semiconductor memory and a non-volatile semiconductor memory. The memory 22 may further include other storage devices, such as a hard disk drive. The memory 22 stores application computer programs and various data to be used for information processing carried out by the processor 23.

All or some of the functions of the data collecting device 11 are, for example, functional modules implemented by a computer program running on the processor 23. The processor 23 includes a control unit 231, a detecting unit 232, and a generating unit 233. Alternatively, the functional module of the processor 23 may be a dedicated arithmetic circuit provided in the processor 23. The processor 23 includes one or more CPUs (Central Processing Units) and their peripheral circuitry. The processor 23 may further include other arithmetic circuitry, such as a logic unit, a numerical unit, or a graphic processing unit. The data collecting device 11 is, for example, an electronic control unit (ECU). Details of the operation of the data collecting device 11 will be described later.

FIG. 1 shows a hardware configuration diagram of the server 30. The server 30 carries out control processing, determination processing, and generating processing. To this end, the server 30 includes a communication interface (IF) 31, storage device 32, memory 33, and processor 34. The communication IF 31, the storage device 32 and the memory 33 are connected to the processor 34 via signal wires 35. The server 30 may further include an input device such as a keyboard and a mouse, and a display device such as a liquid crystal display.

The communication IF 31 has interface circuitry for connecting the server 30 to the communication network 40. The communication IF 31 is configured to communicate with the vehicle 10 through the communication network 40 and the macrocell base station 41. The communication IF 31 is an exemplary server communication unit.

The storage device 32 includes, for example, a hard disk device or an optical storage medium and its access device. The storage device 32 stores probe data and images transmitted from the vehicle 10, the high-precision map, the collection target area, and the collection lane information representing the lane for which it is necessary to collect probe data, and the like. The storage device 32 may also store computer programs for performing the processing associated with the data collecting of the server 30 and the processing for generating and updating the high-precision map executed on processor 34. The storage device 32 is an example of a storage unit.

The memory 33 includes, for example, a volatile semiconductor memory and a non-volatile semiconductor memory. The memory 33 stores computer programs and various types of data for applications used for information processing carried out by the processor 34. The memory 33 is an example of a storage unit.

All or some of the functions of the server 30 are functional modules implemented, for example, by a computer program running on the processor 34. The processor 34 includes a control unit 341, a determination unit 342, and a generating unit 343. Alternatively, the functional module of the processor 34 may be a dedicated arithmetic circuit provided in the processor 34. The processor 34 includes one or more CPUs (Central Processing Units) and their peripheral circuitry. The processor 34 may further include other arithmetic circuitry, such as a logic unit, a numerical unit, or a graphic processing unit.

The control unit 341 determines a collection target area in which probe data is collected based on a predetermined area for generating or updating the high-precision map. The collection target area is designated, for example, for each of one or more consecutive road sections. The information representing the collection target area includes, for example, information capable of determining the road section with positioning information based on GNSS information. The control unit 341 sets a target number of probe data to be collected for each of the lane sections associated with the road section of the collection target area.

The control unit 341 transmits the collection target area to the vehicle 10 using the communication IF 31 at the area notification time having a predetermined period. The control unit 341 updates the acquisition number of probe data for each lane section each time probe data is received from the vehicle 10. The target number and the acquisition number of probe data for each lane section are examples of the collection lane information.

The determination unit 342 generates a determination result based on the lane information included in the determination information and the collection lane information each time the determination information is received.

First, the determination unit 342 acquires the position and the traveling direction of the vehicle 10 in the data collection period in which probe data is generated based on the position information included in the determination information. Then, the determination unit 342 specifies the road section within the collection target area based on the position and the traveling direction of the vehicle 10 when probe data is generated. The determination unit 342 compares the target number of probe data with the acquisition number for the lane represented by the lane information among the lane sections associated with the road section. Here, the lane information represents the position of the lane of the road where the vehicle 10 was traveling when the road feature represented by probe data is detected.

When the acquisition number of probe data is smaller than the target number, the determination unit 342 generates a determination result including the transmission request for transmitting probe data. On the other hand, when the acquisition number of probe data matches the target number, the determination unit 342 generates a determination result that does not include the transmission request.

The lane information indicates whether the lane in which the vehicle 10 is traveling is positioned at the leftmost side or rightmost side of the road or other than the leftmost and rightmost sides of the road.

The lanes positioned on the leftmost side and lanes positioned at the rightmost side of the road are examples of lanes in which the acquisition number of probe data is difficult to reach the target number. On the other hand, a lane positioned on the leftmost side, or a lane positioned at the rightmost side of the road is often arranged with the road features.

The determination unit 342 generates a determination result including the transmission request for transmission of probe data until the acquisition number of probe data reaches the target number for a lane positioned at the leftmost side, a lane positioned at the rightmost side, and a lane positioned at other than the leftmost and the rightmost sides.

When the road has three lanes, the number of lanes in position other than the leftmost and the rightmost sides is one. In this case, the target number is set for this one lane. On the other hand, when the road has four lanes, the number of lanes in positions other than the leftmost and the rightmost sides is two. In this case, the target number may be set to be twice the target number set for one lane. Since the number of the vehicles traveling in the lane at positions other than the leftmost and the rightmost sides is relatively large, statistically, almost the same number of probe data can be collected for each lane.

The determination unit 342 may generate a determination result for requesting transmission of an image representing the environment around the vehicle 10 together with probe data. For example, for a lane section in which a change of a road feature is detected, it is preferable to acquire an image of the lane section to confirm the change of the road feature. In this case, the determination unit 342 generates a determination result that includes a request to transmit the images along with probe data.

The generating unit 343 generates a high-precision map using collected probe data and images. In addition, the generating unit 343 updates the high-precision map using collected probe data. For example, the generating unit 343 compares the newly collected road features with the road features collected in the past with respect to the lane sections to be updated. When there is no previously collected road feature corresponding to the newly collected road feature, the generating unit 343 determines that a new road feature has been installed in the lane section. In addition, when there is no newly collected road feature corresponding to the road feature collected in the past, the generating unit 343 determines that the road feature has been removed from the lane section. The generating unit 343 adds or deletes the road feature in association with the lane section to update the high-precision map. The high-precision map is stored in the storage device 32. The generating unit 343 distributes the high-precision map to the automatic driving vehicles through the communication IF 31.

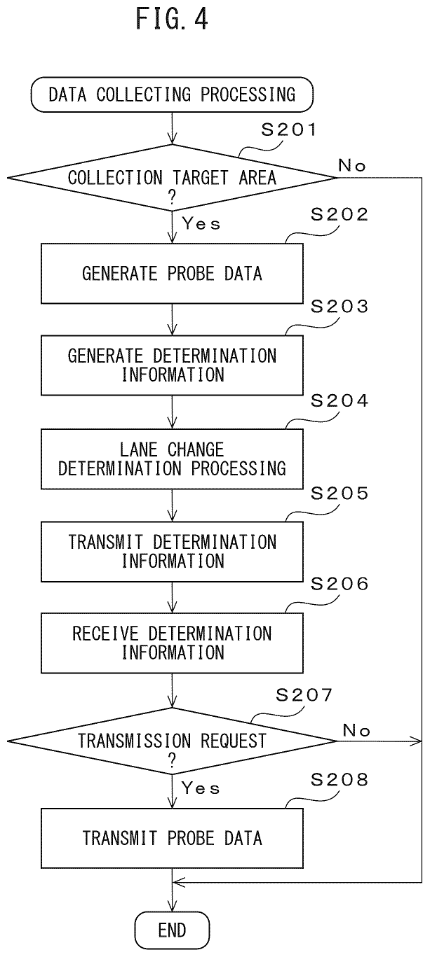

FIG. 4 is an example of an operation flowchart of the data collecting processing of the data collecting device 11. The data collecting processing by the data collecting device 11 will be described below with reference to FIG. 4. The data collecting device 11 carries out the data collecting processing shown in FIG. 4 for each data collecting processing time having a predetermined period.

First, the control unit 231 determines whether or not the present position of the vehicle 10 represented by the positioning information is included in the collection target area (step S201).

When the present position of the vehicle 10 is included in the collection target area (step S201—Yes), the detecting unit 232 generates probe data representing the road feature based on the camera image (step S202). The detecting unit 232 may generate a group of probe data including a plurality of probe data for each data collection period. For example, the data collection period can be a predetermined period (e.g., 10 seconds to a few minutes) or a predetermined distance (e.g., 100 m to 1 km) traveled by the vehicle 10.

The detecting unit 232 detects a predetermined road feature from the camera image. The predetermined road feature is a road feature represented in a high-precision map to be generated or updated. For example, the predetermined road features are various road signs, road edges, guardrails, poles for installing traffic signals or road signs, etc. The detecting unit 232 generates probe data representing the type of the road feature and the position of the road feature detected on the camera image.

For example, the detecting unit 232 includes a classifier that is trained to detect road features represented in an input image. As the classifier, for example, a deep neural network (DNN) trained in advance so as to detect an area and a type of a road feature represented in the image can be used.

The detecting unit 232 may use a classifier other than DNN. For example, the detecting unit 232 may use, as the classifier, a support vector machine (SVM) that is trained in advance so as to output a confidence degree in which a road feature to be detected is represented in a window by inputting a feature quantity (for example, Histograms of Oriented Gradients, HOG) calculated from the window set on the image. Alternatively, the detecting unit 232 may detect the road feature by performing template matching between the template on which the road feature to be detected is represented and the image.

The detecting unit 232 estimates the position of the road feature represented in the object area on the basis of the orientation from the camera 2 which correspond to the center of gravity of the object area detected from the camera image, the position of the vehicle 10 at the time of image generation, the traveling direction of the vehicle 10 and the imaging direction of the camera 2, parameters such as the focal length, and the installation position.

In addition, the detecting unit 232 tracks one road feature detected from the camera image and acquires an area of the road feature represented in each of the two camera images. The detecting unit 232 may estimate the position of the road feature using the triangulation method based on the area of the road feature represented in the two camera images and the position and the traveling direction of the vehicle 10 at each camera image acquisition time.

The detecting unit 232 generates probe data including information representing the type and the estimated position of the detected road feature. The detecting unit 232 stores probe data in the memory 22 in association with position information representing the position of the vehicle 10 at the camera image acquisition time when the camera image was acquired. A group of probe data including position information of the vehicle 10 aligned in a time series and probe data associated with the position information is stored in the memory 22.

The detecting unit 232 may store the camera image at the time when probe data is detected in the memory 22 in association with the position information representing the position of the vehicle 10 at the camera image acquisition time when the camera image is acquired. In the memory 22, a group of the camera images including the position information of the vehicle 10 aligned in a time series and the camera images associated with the position information is stored.

Next, the generating unit 233 generates the determination information including the lane information based on the camera image (step S203). The camera image is an example of information representing a lane marking line around the vehicle 10. The generating unit 233 generates a plurality of lane information within a data collection period in which probe data is generated.

In particular, the generating unit 233 generates lane information representing whether the lane in which the vehicle 10 is traveling is positioned at the leftmost side of the road, the rightmost side of the road, or other than the leftmost and rightmost sides of the road.

For example, the generating unit 233 has a classifier that is trained to detect a lane marking line represented in an input image. As the classifier, for example, a deep neural network (DNN) trained in advance so as to detect an area and a type of a lane marking line represented in the image can be used. The classifier may detect a road edge.

The generating unit 233 may use a classifier other than DNN. For example, the generating unit 233 may use, as the classifier, a support vector machine (SVM) that is trained in advance so as to output a confidence degree in which a lane marking line to be detected is represented in a window by inputting a feature quantity (for example, Histograms of Oriented Gradients, HOG) calculated from the window set on the image. Alternatively, the generating unit 233 may detect the lane marking line by performing template matching between the template on which the lane marking line to be detected is represented and the image.

Based on the areas of the lane marking lines in the camera image, the generating unit 233 detects the lane marking line positioned at the left side of the vehicle 10 and the lane marking line positioned on the right side of the vehicle 10. Since the imaging direction of the camera 2 relative to the traveling direction of the vehicle 10 is known, the assumed range in which the lane marking line on the camera image is represented is also known. This assumed range includes the left area and the right area with respect to the traveling direction of the vehicle 10. The generating unit 233 determines whether or not the lane marking line is detected in the assumed range. In addition, the solid line and the chain line are detected as the type of the lane marking line. Then, the generating unit 233 generates the lane information based on the type of the lane marking line positioned at the left and right sides of the vehicle 10. When the classifier can detect the road edge, the generating unit 233 may generate the lane information based on the position of the road edge.

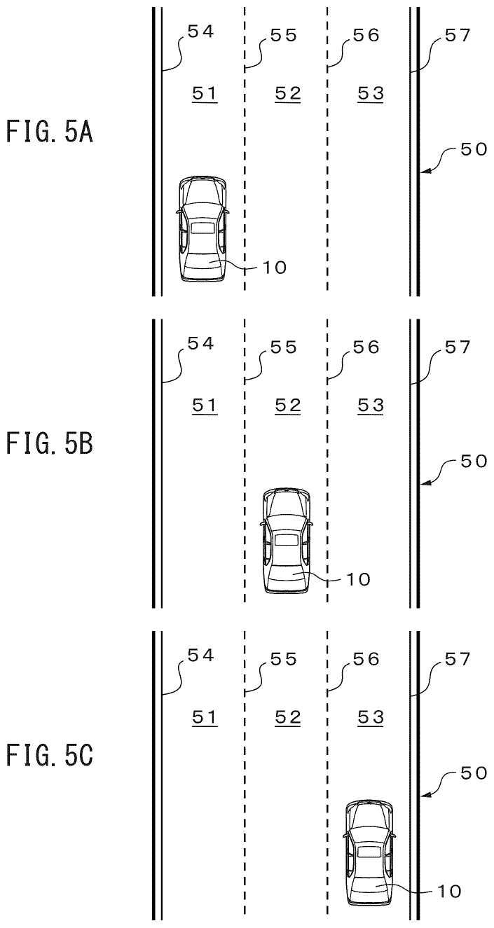

FIG. 5A through 5C are diagrams explaining the generation of the lane information. FIG. 5A is a diagram in which the vehicle 10 is traveling in the lane positioned at the leftmost side. FIG. 5B is a diagram in which the vehicle 10 is traveling in the lane positioned at other than the leftmost and the rightmost sides. FIG. 5C is a diagram in which the vehicle 10 is traveling in the lane positioned at the rightmost side.

The generating unit 233 detects that the lane marking line 54 of the solid line is positioned at the left side of the vehicle 10 and detects that the lane marking line 55 of the chain line is positioned at the right side of the vehicle 10 based on the camera image acquired in the state shown in FIG. 5A. The generating unit 233 generates lane information representing that the lane 51 in which the vehicle 10 is traveling is positioned at the leftmost side of the road 50 based on the camera image.

The generating unit 233 detects that the lane marking line 55 of the chain line is positioned on the left side of the vehicle 10 and detects that the lane marking line 56 of the chain line is positioned at the right side of the vehicle 10 based on the camera image acquired in the state shown in FIG. 5B. The generating unit 233 generates lane information representing that the lane 52 in which the vehicle 10 is traveling is positioned at other than the leftmost and rightmost sides of the road 50 based on the camera image.

The generating unit 233 detects that the lane marking line 56 of the chain line is positioned at the left side of the vehicle 10 and detects that the lane marking line 57 of the solid line is positioned at the right side of the vehicle 10 based on the camera image acquired in the state shown in FIG. 5C. The generating unit 233 generates lane information representing that the lane 53 in which the vehicle 10 is traveling is positioned at the leftmost side of the road 50 based on the camera image.

The generating unit 233 associates the lane information detected from each of the camera images with the position information representing the position of the vehicle 10 at the camera image acquisition time at which this camera image was acquired and stores it in the memory 22.

The generating unit 233 determines whether or not the vehicle 10 is moving between the lanes of the road based on the camera image. The generating unit 233 determines that the vehicle 10 is moving between the lanes of the road when the lane marking line is not detected in an assumed range in which the lane marking line on the camera image is assumed to be represented. When it is determined that the vehicle 10 is moving between the lanes of the road, the generating unit 233 stores a movement flag representing that the vehicle 10 is moving between the lanes in the memory 22, in association with the position information representing the position of the vehicle 10 at the camera image acquisition time when the camera image is acquired.

The generating unit 233 generates the determination information including the lane information, the movement flag, and the position information in association with the data collection period and stores the determination information in the memory 22. The determination information includes the position information aligned in a time series and the lane information and the movement flag associated with the position information. In addition, when the vehicle 10 is not moving between the lanes of the road, the determination information does not include the movement flag.

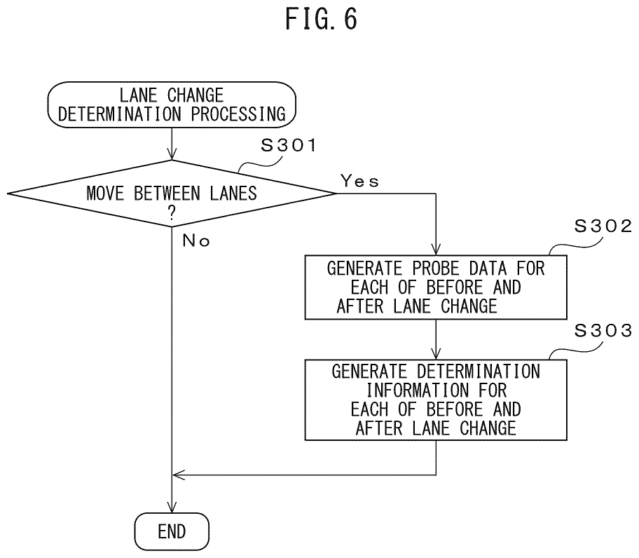

Next, the data collecting device 11 carries out lane change determination processing (step S204). This lane change determination processing will be described below with reference to FIG. 6.

FIG. 6 is an example of an operation flowchart of the lane change determination processing of the data collecting device 11. First, the generating unit 233 determines whether or not the vehicle 10 has moved between the lanes of the road within the data collection period on the basis of the movement flag generated using the camera image (step S301). Since the camera image is an example of information representing a lane marking line around the vehicle 10, a movement flag is also generated based on the camera image. Determining whether or not the vehicle 10 has moved between the lanes of the road based on the movement flag is an example of determining whether or not the vehicle 10 has moved between the lanes of the road based on information representing the lane marking line around the vehicle 10.

When the determination information includes the movement flag, the generating unit 233 determines that the vehicle 10 has moved between the lanes of the road. On the other hand, when the determination information does not include the movement flag, the generating unit 233 determines that the vehicle 10 has not moved between the lanes of the road.

When the vehicle 10 has moved between the lanes of the road (step S301—Yes), the detecting unit 232 generates a first group of probe data including a plurality of probe data representing the road features detected in a lane before movement between the lanes, and a second group of probe data including a plurality of probe data representing the road features detected in a lane after movement between the lanes (step S302).

The detecting unit 232 generates a plurality of probe data associated with the positions before the position of the vehicle 10 associated with the movement flag included in the determination information, as the first group of probe data. The detecting unit 232 generates a plurality of probe data associated with the positions behind the position of the vehicle 10 associated with the movement flag included in the determination information, as the second group of probe data. The first group of probe data and the second group of probe data are generated based on the group of probe data during the data collection period. The first group of probe data and the second group of probe data are stored in the memory 22.

The generating unit 233 generates a plurality of the camera images associated with the positions before the position of the vehicle 10 associated with the movement flag included in the determination information, as the first group of the camera image. The generating unit 233 generates a plurality of the camera images associated with the positions behind the position of the vehicle 10 associated with the movement flag included in the determination information, as the second group of the camera image. The first group of the camera images and the second group of the camera images are generated based on the group of the camera images during the data collection period. The first group of the camera images and the second of the camera images are stored in the memory 22.

Next, the generating unit 233 generates first determination information including a first group of the lane information corresponding to the first group of probe data and second determination information including a second group of the lane information corresponding to the second group of probe data (step S303), and the series of processing steps is complete. The first group of the lane information includes a plurality of the lane information representing a position of the lanes before movement between the lanes. The second group of the lane information includes a plurality of lane information representing a position of the lane after movement between the lanes.

The generating unit 233 generates the plurality of the lane information associated with the positions before the position of the vehicle 10 associated with the movement flag included in the determination information, as the first group of the lane information. The first determination information includes the position information which is aligned in a time series before the vehicle 10 moves between the lanes, and the first group of the lane information associated with the position information.

Further, the detecting unit 232 generates a plurality of the lane information associated with the positions behind the position of the vehicle 10 associated with the movement flag included in the determination information, as the second group of the lane information. The second determination information includes the position information that is aligned in a time series after the vehicle 10 moves between the lanes, and a second group of the lane information associated with the position information. The first determined information and the second determination information are generated based on the determination information during the data collection period. The first determined information and the second determination information are stored in the memory 22.

On the other hand, when the vehicle 10 does not move between the lanes of the road (step S301—No), and the series of processing steps is complete. The above is a description of the lane change determination processing.

Next, the control unit 231 transmits the determination information to the server 30 through the communication device 3 (step S205). When the vehicle 10 has moved between the lanes during the data collection period, the control unit 231 transmits the first determination information and the second determination information to the server 30. On the other hand, when the vehicle 10 does not move between the lanes during the data collection period, the control unit 231 transmits one determination information to the server 30. The control unit 231 is an example of a communication control unit.

Next, the control section 231 receives the determination result from the server 30 through the communication device 3 (step S206). When the vehicle 10 has moved between the lanes during the data collection period, the determination result includes the presence or absence of a transmission request for each of before and after the movement between the lanes of the vehicle 10. Probe data may be required to be transmitted only before, only after, and both before and after the movement between the lanes.

Next, the control unit 231 determines whether or not the determination result includes the transmission request (step S207). When the determination result includes the transmission request (step S207—Yes), the control unit 231 transmits the group of probe data to the server 30 through the communication device 3 (step S208), and the series of processing steps is complete. The control unit 231 is an example of an information control unit.

When the vehicle 10 has moved between the lanes during the data collection period in which probe data is generated, probe data is transmitted to the server 30 corresponding to the determination result. The controller 231 transmits the first group of probe data or/and the second group of probe data to the server 30 through the communication device 3.

On the other hand, when the vehicle 10 has not moved between the lanes during the data collection period, the control unit 231 transmits one group of probe data to the server 30.

When the determination result includes the transmission of probe data and the transmission of the images, the control unit 231 transmits the group of the camera images together with the group of probe data to the server 30 through the communication device 3.

In this case, when the vehicle 10 has moved between the lanes during the data collection period, the control unit 231 transmits the first group of the camera images or/and the second group of the camera images to the server 30 through the communication device 3. On the other hand, when the vehicle 10 has not moved between the lanes during the data collection period, the control unit 231 transmits one group of the camera images to the server 30.

On the other hand, when the determination result does not include the transmission request (S207—No of steps), the series of processing steps is complete.

The data collecting system of the present embodiment described in detail above can collect probe data by determining a position of a lane in a road in which the vehicle is traveling and collecting probe data without using a high-precision map. Thus, the data collecting system transmits probe data to the server when the vehicle is traveling in a lane where collection of probe data is necessary. On the other hand, when the vehicle is traveling in a lane where collection of probe data is not necessary, the vehicle does not transmit probe data to the server.

Further, in the data collecting system of the present embodiment, since probe data is transmitted to the server only when traveling in the lane where collection of probe data is necessary, probe data of each lane of the road having a plurality of lanes can be efficiently collected.

In the present invention, the data collecting device and the data collecting system of the above-described embodiment can be appropriately changed without departing from the spirit of the present invention. Further, the technical scope of the present invention is not limited to those embodiments, but extends to the invention described in the claims and its equivalents.

For example, in the above-described embodiment, a plurality of lane information has been transmitted to the server for each data collection period, but the lane information may be transmitted to the server each time probe data is generated. When the determination result including the transmission request is received, probe data is transmitted to the server.

In the above-described embodiment, the lane information generated by the data collecting device includes information representing that the lane of the road in which the vehicle is traveling is positioned at the leftmost side or rightmost side, or other than the leftmost and rightmost sides. The lane information is not particularly limited, as long as it represents the position of a lane in a road in which the vehicle is traveling when the road feature represented by probe data is detected. For example, the lane information may include, for the traveling direction of the vehicle, left side information representing a road feature partitioning the left end of the traveling lane and right side information representing a road feature partitioning the right end of the traveling lane.

Specifically, as the left side information, a lane marking line of a solid line or a chain line, or a road edge. Further, as the right side information, a lane marking line of a solid line or a chain line, or a road edge. In this case, the server can determine, based on the left side information and the right side information, whether a position of a lane in a road in which the vehicle is traveling is the lane positioned at the leftmost side, the lane positioned at the rightmost side, or the lane at a position other than the leftmost and rightmost sides.

1. A data collecting device comprising:
a processor configured to
generate probe data representing a road feature based on information representing an environment around a vehicle,
generate lane information representing a position of a lane in a road in which the vehicle was traveling when the road feature represented by the probe data was detected, based on information representing a lane marking line around the vehicle,
transmit the lane information via a communication unit and receive a determination result representing whether or not there is a transmission request for transmitting the probe data, which is determined based on the lane information, and
transmit the probe data via the communication unit when the determination result representing the transmission request is received.

2. The data collecting device according to claim 1, wherein the lane information includes information representing whether the lane in which the vehicle travels is traveling on the leftmost side of the road, on the rightmost side of the road, or other than the leftmost and rightmost sides of the road.

3. The data collecting device according to claim 1, wherein the lane information includes left side information representing a road feature partitioning the left end of the traveling lane relative to a direction of travel of the vehicle and right side information representing a road feature partitioning the right end of the traveling lane relative to the direction of travel of the vehicle.

4. The data collecting device according to claim 1, wherein the processor is further configured to
generate a group of probe data including a plurality of the probe data for each predetermined data collection period,
determine whether or not the vehicle has moved between lanes in a road within the data collection period based on the information representing the lane marking line around the vehicle, and
generate a first group of the probe data including a plurality of the probe data representing the road feature detected in a lane before movement between lanes and a second group of the probe data including a plurality of the probe data representing the road feature detected in a lane after movement between lanes, and a first group of the lane information including a plurality of the lane information representing a position of the lane before movement between lanes corresponding to the first group of the probe data and a second group of the lane information including a plurality of the lane information representing a position of a lane after movement between lanes corresponding to the second group of the probe data, when it has been determined that the vehicle has moved between lanes of the road within the data collection period.

5. A data collecting system comprising:
a data collecting device comprising:
a device communication unit; and
a device processor configured to
generate probe data representing a road feature based on information representing an environment around a vehicle,
generate lane information representing a position of a lane in a road in which the vehicle was traveling when the road feature represented by the probe data was detected, based on information representing a lane marking line around the vehicle,
transmit the lane information via the device communication unit and receive a determination result representing whether or not there is a transmission request for transmitting the probe data, which is determined based on the lane information, and
transmit the probe data via the device communication unit when the determination result representing the transmission request is received; and
a server comprising:
a server communication unit; and
a server processor configured to
generate the determination result based on the lane information received via the server communication unit and collection lane information representing a lane for which it is necessary to collect the probe data, and
transmit the determination result to the data collecting device via the server communication unit.
